(19) United States
(12) Patent Application Publication
(10) Pub. No.: US 2003/0164979 A1
(43) Pub. Date: Sep. 4, 2003

(54) Information processing method, information processor, and information processing system

(76) Inventor: Yasunori Shimakawa, Tokyo (JP)

Correspondence Address: DELLETT AND WALTERS, 310 S.W. FOURTH AVENUE, SUITE 1101, PORTLAND, OR, 97204, US

(21) Appl. No.: 10/310,688

(22) Filed: Dec. 4, 2002

(30) Foreign Application Priority Data
Dec. 5, 2001 (JP) 2001-371866

(51) Int. Cl. G06F 15/00; B41J 1/00

(52) U.S. Cl. 358/1.18; 358/1.15

(57) ABSTRACT

In the copy or print services that use a copier or a printer installed in a store such as a convenience store, document image information to be copied or printed is combined with pre-registered specific image information (any distribution information such as an advertisement) and the information is output into areas, each providing for each type of the information, on the same surface. Prior to this, a user who wants to distribute information at the front end of the store registers the information at the front end or on a web. The user who registers information pays a registration fee. A copy service user, who permits the distribution information to be output with document image information, gets a discount for using the service.

### DETAILED DESCRIPTION

1. Field of the Invention

The present invention relates to the distribution of information, and more particularly to a method, processor, and system that distribute registered information to an unspecified number of persons.

2. Related Art

Conventionally, there have been services allowing individuals to provide various types of information. Information is provided in various ways. For example, information is delivered using an Internet web, placed in an advertisement column of newspapers or magazines for advertisement, put on a bulletin board installed in department stores or public facilities, posted on magazines, or directly sent via direct mails. However, because each of the methods given above has good and bad points, there has been a need for services with which many individuals can provide information easily and economically.

The conventional information providing services described above each have some problems with the way the information is provided.

When information is provided using an Internet web, only the advertisements for users on the terminals (PC) connected to the Internet web may be provided. Another problem is that information must also be provided to notify the users of the address at which the advertisement is provided. One of the solutions to this address problem is to place the information in an advertisement site. However, because many advertisements are placed at this advertisement site, there is no guarantee that intended users view the advertisement. In addition, the advertisement cannot be limited to a particular local area.

Advertisement information placed in the advertisement column of newspapers or magazines attracts the attention of more persons. However, the advertisement cost is high and the place and the size of the advertisement depend on the cost.

Information may be placed on a bulletin board easily, but it is less likely that intended persons will notice the advertisement.

Information may be posted on magazines, for example, on a community information magazine or a magazine carrying a personal buying and selling article, or a request is made to place the information in such a magazine at a cost. However, it takes long before the magazine is issued and, in addition, it is not guaranteed that the information always attracts attention.

Sending information directly to persons via direct mail is costly and inefficient because the mails must be sent to an unspecified number of persons.

To provide an advertisement more simply and efficiently, Japanese Patent Laid-Open Publications No. 11-192760, 11-261798, 11-355549, 2000-194932, and 2000-357071 propose systems that place an advertisement on a new medium such as a copy paper or FAX paper. However, there is room for improvement in those systems in order for anybody to place an advertisement easily, simply, and economically.

### SUMMARY OF THE INVENTION

In view of the foregoing, it is an object of the present invention to provide an information processing method, information processor, and information processing system that allow users to distribute specific image information such as an advertisement easily, simply, and economically.

An image processing method according to the present invention relates to the document image information output services, which use image processors such as a copier or a printer installed, for example, in a store such as a convenience store, to output document image information. That is, information to be distributed (for example, any distribution information such as advertisement information, inquiry, and announcement) is created and registered at the front end of the store or on a web, registered information is delivered to an image processor in the stores connected to the network and, when the image processor is used for the output services, the registered information is output in conjunction with document image information.

When document image information is output by a copier or a printer, this method outputs the document image information as well as registered distribution information to notify the user of the registered information. The service provider gets paid for registering distribution information and, at the same time, an image processor user gets a discount for using the service.

The present invention includes an information processing method, an information processor, an information processing system including the information processors, and a form where information that is registered during the information processing according to the present invention is written.

An information processing method according to the present invention for outputting document image information comprises the steps of image-processing the document image information and pre-registered specific image information; and outputting the image-processed document image information and specific image information into respective areas prepared on the same surface therefor. With the specific image information as distribution information, the distribution information may be output with the document image information.

An embodiment of an image information processing method according to the present invention performs image-combining and/or image-editing processing for document image information and registered specific image information for outputting the information as images, wherein image information and attribute information of the specific image information are registered using a form with a specific format. The image information of the specific image information may include image data or character data or both. Not only is the form used for registering the image information and attribute information of the specific image information but also the attribute information is used for calculating a fee required for registration.

The attribute information includes output mode information on the specific image information and, based on the output mode information, an output mode is set and a fee required for registration is calculated. The attribute information includes, for example, the number of output copies, distribution area, publication time zone, publication period, publication unit fee, publication format, and category to which the specific image information belongs. The publication format includes, for example, whether or not the advertisement is published singly or as one of a plurality of advertisements, selection of an insertion position on the output surface, and output selection between color and monochrome.

The form may have a plurality of areas for registering the image information of the specific image information, and a fee required for registration may be set according to an area in which the image information of the specific image information is inserted, the area being one of the plurality of areas. The fee required for registration may be reflected on the charge required for outputting an image, and at least part of the registration fee may be reduced from the charge for outputting the image.

The form is available at the front end or may be obtained from the server and output on the image processor as an image. The form may also be displayed on the image screen of a front end terminal or a registration terminal.

A form printed on paper may have a bar code or an identification number identifying the form. This bar code or identification number may be used to identify the pattern or the shape of a form that is set in each of a plurality of areas. The attribute information described on the form may be obtained by reading by an image reader as image data. For example, the attribute information described on a mark sheet may be read by an image reader with the OCR (Optical Character Reader) function.

When a charge (price) is collected for a form that is output as an image on the image processor, at least part of an output charge of the form may be refunded when the form is registered.

A charge required for outputting only an image of the document image information may be made different from a charge required for outputting an image of the document image information and the specific image information. When the specific image information is output, the user is given a discount on the charge. This will promote the output of specific image information (for example, copy service is used)

In addition, a POS system may be used in the method according to the present invention, and the mode described below in which the POS system is used is provided.

At least the attribute information of the form is sent from a terminal to a POS system and, in the POS system, the fee may be displayed and the attribute information may be changed. At least the attribute information described on the form is sent to the POS system and the POS system receives the fee calculated based on the attribute information.

A POS system may be connected to a server via a network, wherein the server sends registration information, which is registered via the network using the form, by electronic mail or postcard to which identification information identifying the registration information is attached, and wherein the POS system may receive a fee for registering the image information from the user based on an attached bar code or an identification number.

A POS system may be connected to a server via a network, wherein the server counts a number of output copies of the registered image information, outputs a number of image copies registered in the attribute information, and notifies a user (registrant) by electronic mail or postcard that the output of the image has been terminated.

A POS system may be connected to a server via a network, wherein the server counts a number of output copies of the registered image information and, when an output period registered in the attribute information expires before a number of output copies registered in the attribute information are output, notifies a user of the number of output copies by electronic mail or postcard to which identification identifying the registered information is attached, and wherein, if the output period is to be extended in response to an instruction from the user, the POS system or the server on the network extends the registration identified by the identification information.

A POS system may be connected to a server via a network, wherein the server counts a number of output copies of the registered image information and, when an output period registered in the attribute information expires before a number of output copies registered in the attribute information are output, notifies a user of the number of output copies by electronic mail or postcard to which identification identifying the registered information is attached, and wherein the POS system refunds a remainder of the fee of the registration identified by the identification information.

The image processing may be copy processing in which a document image is copied for output or output processing in which image data received via a recording medium, a digital camera, or a network is output.

An information processor according to the present invention image-processes document image information and pre-registered specific image information for outputting the information, wherein the document image information and the specific image information are output into respective areas prepared on the same surface therefor.

An embodiment of an information processor according to the present invention performs image-combining and/or image-editing processing for document image information and registered specific image information for outputting the information as images, comprising a registration unit that registers image information and attribute information of the specific image information described on a form with a specific format. The image information of the specific image information may include image data and/or character data. The information processor may further comprises a fee calculation unit that calculates a fee required for registration using the attribute information of the specific image information described on the form.

The attribute information may include output mode information on the specific image information, the registration unit may set an output mode based on the output mode information, and the calculation unit may calculate a fee required for registration based on the output mode information.

The information processor is a copier that copies a document image for output or an output unit that outputs image data received via a recording medium, a digital camera, or a network.

An information processing system according to the present invention connects, via a network, an information processor; a server that has a form with a particular format for describing image information and attribute information of the specific image information; and terminals, wherein the information processor obtains the image information and the attribute information of the specific image information via the form sent from the terminals via the server. The server uses the received form to register the image information and the attribute information of the specific image information, calculates a fee required for the registration, and displays the fee on the information processor. The server counts a number of output copies of the registered image information, outputs images up to a number of output copies registered in the attribute information, and informs a registrant by electronic mail or postcard that the output of the images has been terminated.

A form used by the present invention has a format in which a recording area is divided into a first area that is a recording area of document image information during recording and a second area that is a recording area of specific image information during recording, wherein attribute information of the specific image information is included in the first area and image information of the specific image information is included in the second area. The second area may have a plurality of divided areas, and the attribute information in the first area is attribute information on one of the image information in the divided areas.

The format may be described on paper or displayed on a screen. The form may have thereon a bar code or an identification number identifying the form.

### BRIEF DESCRIPTION OF THE DRAWINGS

FIG. 1 is a block diagram showing the overview of information processing according to the present invention.

FIG. 2 is a block diagram showing the overview of the configuration of an information processing system according to the present invention.

FIG. 3 is a block diagram of a store for illustrating a handwriting registration procedure at a front end according to the information processing of the present invention.

FIG. 4 is a sequence diagram showing the handwriting registration procedure at the front end according to the information processing of the present invention.

FIG. 5 is a diagram showing an example of a form used for handwriting registration at the front end according to the information processing of the present invention.

FIG. 6 is a diagram showing the reading of a predetermined form at the front end according to the information processing of the present invention.

FIG. 7 is a diagram showing an output example of a form used in the information processing according to the present invention.

FIG. 8 is a diagram showing an example of a form used in the information processing according to the present invention.

FIG. 9 is a diagram showing an example of a confirmation screen used in the information processing according to the present invention.

FIG. 10 is a flowchart showing an example of a fee calculation procedure in the information processing according to the present invention.

FIG. 11 is a block diagram showing the configuration of a front end terminal for illustrating a registration procedure via the terminal used in the information processing according to the present invention.

FIG. 12 is a block diagram showing the configuration of a registration terminal for illustrating the registration procedure via the terminal used in the information processing according to the present invention.

FIG. 13 is a sequence diagram showing the signal transfer between a server and a front end terminal performed in the registration procedure via the terminal used in the information processing according to the present invention.

FIG. 14 is a sequence diagram showing the signal transfer between the server and the front end terminal performed in the registration procedure via the terminal used in the information processing according to the present invention.

FIG. 15 is a diagram showing an example of a registration form filled in via the terminal used in the information processing according to the present invention.

FIG. 16 is a diagram showing an example of a registration form filled in via the terminal used in the information processing according to the present invention.

FIG. 17 is a diagram showing an example of a registration form filled in via the terminal used in the information processing according to the present invention.

FIG. 18 is a diagram showing an example of a registration form filled in via the terminal used in the information processing according to the present invention.

FIG. 19 is a diagram showing an example of a registration form filled in via the terminal used in the information processing according to the present invention.

FIG. 20 is a block diagram showing the configuration of a terminal for illustrating the registration procedure via the terminal used in the information processing according to the present invention.

FIG. 21 is a sequence diagram showing the signal transfer between the server and the terminal performed in the registration procedure via the terminal used in the information processing according to the present invention.

FIG. 22 is a diagram showing an example of a form filled in using a web via the terminal used in the information processing according to the present invention.

FIG. 23 is a diagram showing an example of a form filled in using a web via the terminal used in the information processing according to the present invention.

FIG. 24 is a diagram showing an example of a form filled in using a web via the terminal used in the information processing according to the present invention.

FIG. 25 is a diagram showing an example of a form filled in using a web via the terminal used in the information processing according to the present invention.

FIG. 26 is a flowchart showing an advertisement publication procedure in the information processing according to the present invention.

FIG. 27 is a diagram showing an example of form with divided areas used in the information processing according to the present invention.

FIG. 28 is a diagram showing an example of form with divided areas used in the information processing according to the present invention.

FIG. 29 is a flowchart showing fee-for-service processing in the information processing according to the present invention.

FIG. 30 is a diagram showing an example of a selection screen used in the information processing according to the present invention.

FIG. 31 is a flowchart showing server management in the information processing according to the present invention.

FIG. 32 is a flowchart showing server management in the information processing according to the present invention.

FIG. 33 is a flowchart showing image output processing in the information processing according to the present invention.

FIG. 34 is a diagram showing an example of notification in the information processing according to the present invention.

FIG. 35 is a sequence diagram showing processing performed after an advertisement is published in the information processing according to the present invention.

### DETAILED DESCRIPTION OF THE EMBODIMENTS

Some embodiments of the present invention will be described in detail by referring to the drawings.

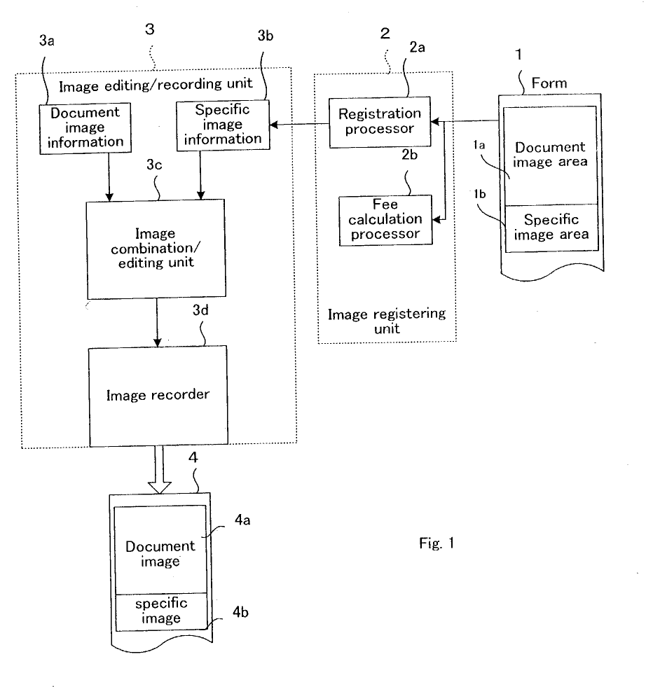

FIG. 1 is a block diagram showing the overview of information processing according to the present invention. In FIG. 1, an image processor 3 is a device that provides services such as copy services, print services, and data output services (collectively called output services). The image processor 3 comprises an image combination editor 3c, which combines the image of document image information 3a and the image of specific image information 3b for editing, and an image recorder 3d which outputs the image. The image recorder 3d outputs an image on paper or as image data. When the image is output on an output form 4, a document image 4a and a specific image 4b are placed in respective predetermined positions. The image processor 3 is, for example, an image processor that outputs an image on copier paper or output an image as image data. The document image information 3a is information prepared by the user of the output services who uses the image processor 3. This information may be images and characters written on paper, data recorded on a recording medium such as a flexible disk, CD-ROM, and semiconductor memory, and data obtained from an image input device such as a digital camera that is set.

On the other hand, the specific image information 3b, which is information registered in advance, is output with the document image information 3a as the specific image 4b on the output form 4 at the same time the document image information is output via the image processor 3. For example, the specific image information 3b is any distribution information such as advertisement information, inquiries, and notices. This specific image information 3b may be image data, character data, or the combination of them. The specific image information 3b is registered in advance in an image registration unit 2 by the provider (registrant) of distribution information and is output from the image processor 3 according to a predetermined condition that will be described later.

The image registration unit 2 comprises a registration processor 2a and a fee calculation processor 2b. The registration processor 2a registers information. In this embodiment, information is registered using a form 1 with a particular format. The fee calculation processor 2b calculates the fee required for registering information. In this embodiment, this processor calculates the fee based on information described on the form 1 with a particular format.

Like the output form 4, the form 1 is divided into two areas: an area (document image area 1a) corresponding to the document image information 3a and an area (specific image area 1b) corresponding to the specific image information 3b. Image information (D1) and attribute information (D2) are described in the document image area 1a and the specific image area 1b. The image information D1, which is distribution information to be registered, is image data or character data or a combination of them. In the description below, an advertisement will be described as a typical example of distribution information. The attribute information D2, which is attached information associated with registered information, includes information on registrants such as the name, address, and contact method used to identify the registrant as well as information on the output mode of the specific image information. The information on the output mode of the specific image information includes the maximum number of output copies, distribution (that is, publication) mode (for example, distribution area, publication time zone, publication period, publication unit fee, publication format), and a category to which the specific image information belongs. The publication format includes, for example, whether the advertisement is inserted singly or in combination with each other, where the advertisement is inserted on the output screen, and whether the advertisement is output in color or in monochrome.

The image registration unit 2 calculates the fee required for registration based on the output mode information on the specific image information included in the attribute information D2. In addition, in response to an output request from the image processor 3, the image registration unit 2 judges which registered information is to be output and sends the registered information to the image processor 3.

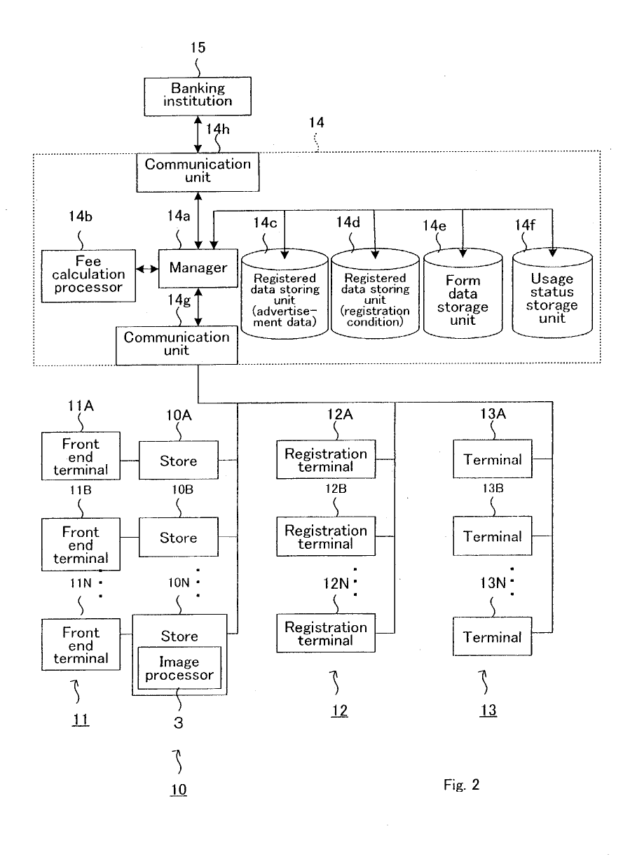

FIG. 2 is a block diagram showing the overview of the configuration of an information processing system according to the present invention. Referring to FIG. 2, the information processing system comprises stores 10 (10A-10N) such as convenience stores in each of which the above-described image processor 3 is installed. At the same time, terminals such as front end terminals 11 (11A-11N), registration terminals 12 (12A-12N), and terminals 13 (13A-13N) are connected to the image processor 3 as part of the image registration unit 2. Those stores and terminals are connected to a server 14 via a network (for example, the Internet).

The front end terminal 11 is a terminal installed in the store 10, the registration terminal 12 is a terminal installed outside the store 10, dedicated for registering information, and the terminal 13 is a personal computer (PC) of the user.

The server 14 is connected to the terminals by a communication unit 14g over the network and is connected to a banking institution 15 by a communication unit 14h. The server 14 has the function of the image registration unit 2; therefore, it has a manager 14a and a fee calculation processor 14b as well as storage units such as registered data storing units 14c and 14d, form data storage unit 14e, and usage status storage unit 14f. The registered data storing unit 14c stores the image information D1 such as advertisement information, and the registered data storing unit 14d stores the attribute information D2. The form data storage unit 14e stores various patterns each with a unique pattern and shape, such as the layouts of the document image area 1a and the specific image area 1b of the form 1. The usage status storage unit 14f sequentially updates usage status information such as the number of registering information outputs and stores this information.

The following describes registration, registered information publication, registration fee calculation, and processing after registration in this embodiment.

First, the registration procedure will be described. Information may be registered via handwriting at the front end of a store, via the front end terminal 11, via the registration terminal 12, or via the terminal 13.

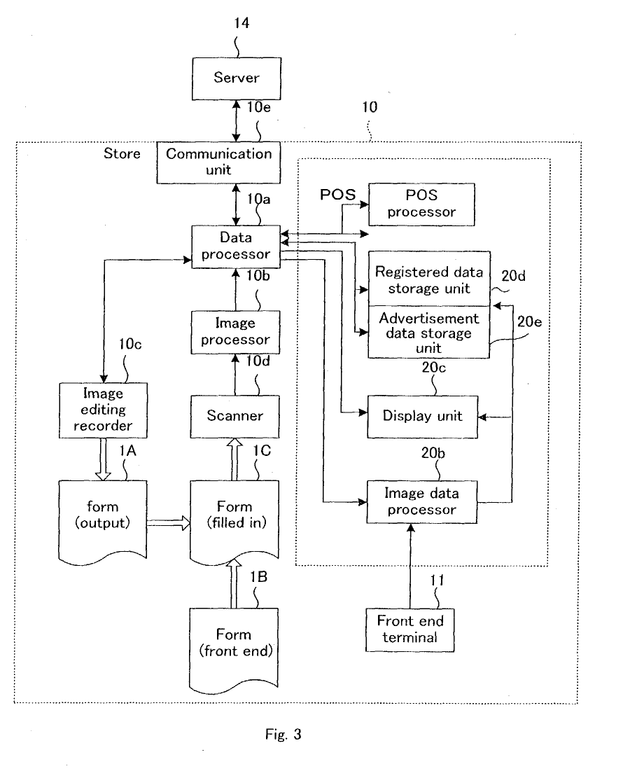

With reference to FIGS. 3-10, the procedure for registering via handwriting at the front end of a store will be described.

FIG. 3 shows an example of the configuration of the store 10. The store 10 has a data processor 10a that performs various types of data processing; for example, it captures image data to be registered, outputs forms, and outputs document image information in which specific image information is embeded. To capture image data to be registered, a scanner 10d captures the image of a form 1C prepared by filling in a form 1B available at the front end of the store to obtain the image, an image processor 10d processes the resulting specific image information (image information D1, attribute information D2), and the data processor 10a stores the information in an image information storage unit 20d and an attribute information storage unit 20e.

To output a form, a form obtained from a storage unit (not shown) provided in the server 14 or the store 10 is output from an image editing recorder 10c as a form 1A for output on paper. The form may be selected using an input unit and a display unit not shown. Document image information and specific image information are output by the image editing recorder 10c.

The store 10 comprises a POS(Point Of Sales) system 20. The POS system 20 processes accounting and stock management at the store. In this embodiment, the POS system 20 comprises not only a POS processor 20a and a display unit 20c, which are usually provided, but also an image data processor 20b and storage means including the image information storage unit 20d and the attribute information storage unit 20e, wherein the image data processor 20b is connected to the front end terminal 11. The image information storage unit 20d and the attribute information storage unit 20e store specific image information received from the scanner 10 d, image processor 10b, or front end terminal 11.

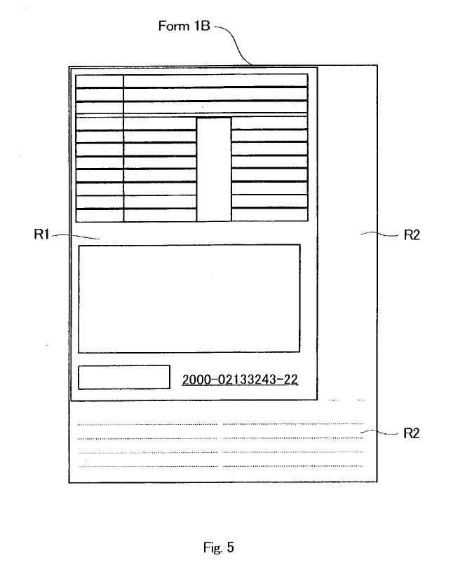

At the front end of a store, a user who wants to register distribution information uses the form 1B available at the front end or the form 1A output on paper by the image editing recorder 10c to fill in the form (1A, 1B) with image information to be registered and attribute information on the image information. The filled-in form 1C is read by the scanner 10d to capture specific image information. FIG. 5 shows an example of the form 1B available at the front end. The form 1B has two areas, first area R1 and second area R2, on a form similar in shape to the form that is output (In FIG. 5, the boundary is indicated by a bold, solid line). The first area R1 is an area in which document image information is recorded when an image is output by the copy services. The form 1B for registration has, in this area R1, a column and a mark sheet in which the attribute information on the specific image information is included as well as a bar code and an identification number. The bar code and the identification number are identification information for uniquely identifying the registration. This identification information may also include information for identifying the shape or the pattern of the form. The bar code and the identification information may also be added later by attaching labels or the like.

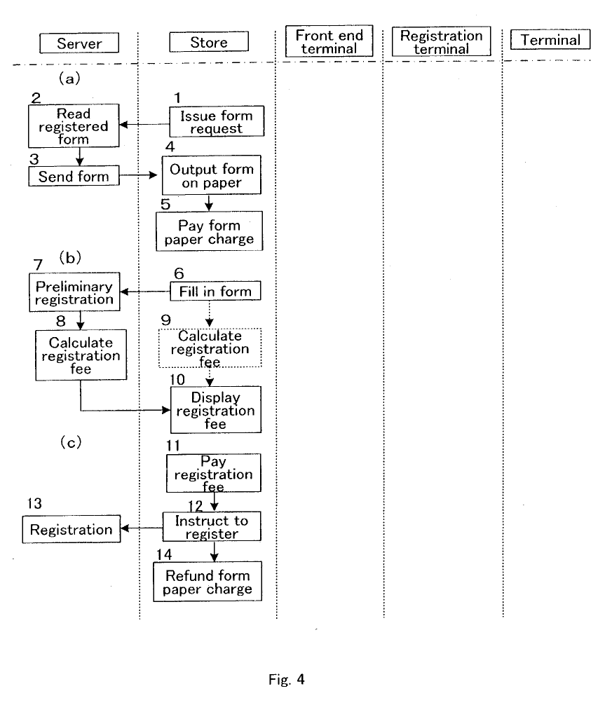

FIG. 4 shows the signals transferred between the server and the front end. A number in parentheses ( ) corresponds to the number in the figure.

FIG. 4(a) shows the procedure for outputting a form from the server to the front end. In response to a form request from the store (1), the server reads a predetermined form (registration form) from the stored registration forms (2) and sends the form to the requesting store (3). The store outputs the received form on paper (4) and collects the form charge from the user who wants to register information.

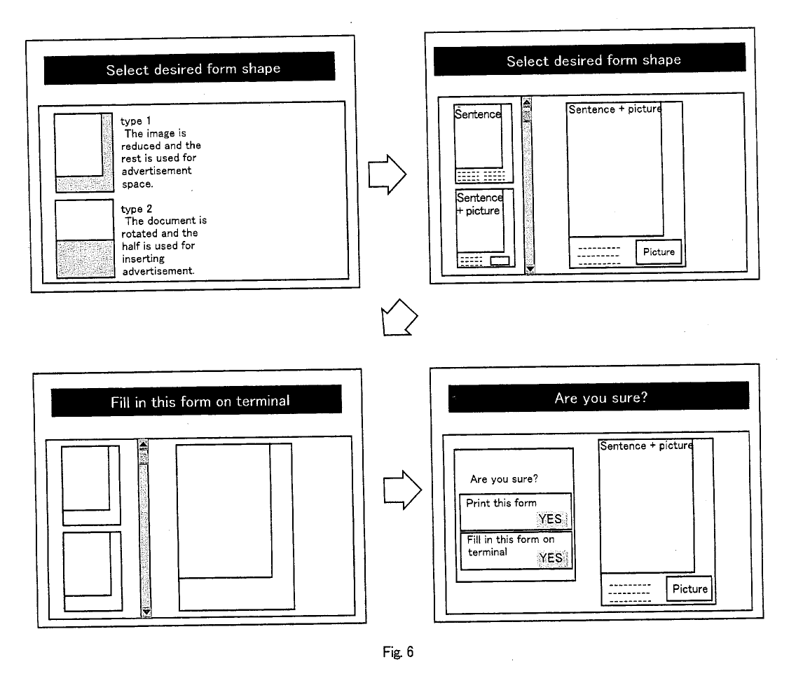

A predetermined form is read, for example, according to the procedure shown in FIG. 6. In the procedure shown in FIG. 6, the user who wants to register information first selects a desired shape pattern of the form. For example, the shape patterns from which the user can select include a pattern with an L-shaped specific image information area indicated by type 1 and a pattern with a specific image information area at the bottom of the form indicated by type 2. Those patterns are examples only and the present invention is not limited to those patterns. Next, the user selects specific image information to be registered using the form, whose shape is indicated by type 1 or type 2, as a pattern composed only of sentences or a pattern that is a combination of sentences and pictures. The specific image information area may contain an example of sentence layouts or an example of sentence and picture layouts according to the corresponding pattern.

After selecting the shape pattern, the user selects a form pattern (background) of the form (In FIG. 6, the illustration of the background is omitted). After the selections are finished, the user selects whether to print the form for output on paper or to display the form on the terminal display screen.

Returning to FIG. 4, FIGS. 4(b) and 4(c) show the procedure for registering specific image information. When the form is output on paper, the user fills in the form with image information and attribute information and puts the form on the scanner provided on the cash desk or the like of the store (6). At this time, the clerk checks if the information is not offensive to public order and morals and then sends the information to the server. The server performs preliminary registration based on the received specific image information (7), calculates the registration fee based on the attribute information and sends the result to the store (8). The calculation of the registration fee may also be done in the store (9). The registration fee may be calculated based on the attribute information described in the specific image information included in the captured image.

After that, the preview screen, which indicates the actual output mode, and the calculated registration fee are displayed on the display (monitor or the like) on the cash desk of the store (10).

The user who wants to register information views the displayed registration fee and, if he or she is satisfied with the fee, pays the fee (11). Entered data may be corrected, if necessary, from the mark sheet section on the POS. After receiving the registration fee, the store instructs the server to register the information (12). In response to the registration instruction, the server registers the specific image information (13). After receiving the registration fee, the store may return the form paper charge collected previously (14). Returning this charge is not essential.

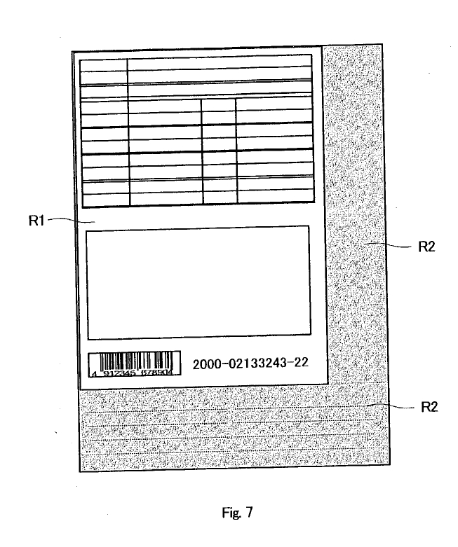

FIG. 7 shows another output example of a selected form. The area R1 in which document image information will be output (top-left corner on the form in this example) includes a column or a mark sheet in which attribute information on specific image information to be registered is entered, notice regarding this service, and a bar code or an identification number for identifying the registration. The form in this example has a background in the area R2 where the specific image information is attached.

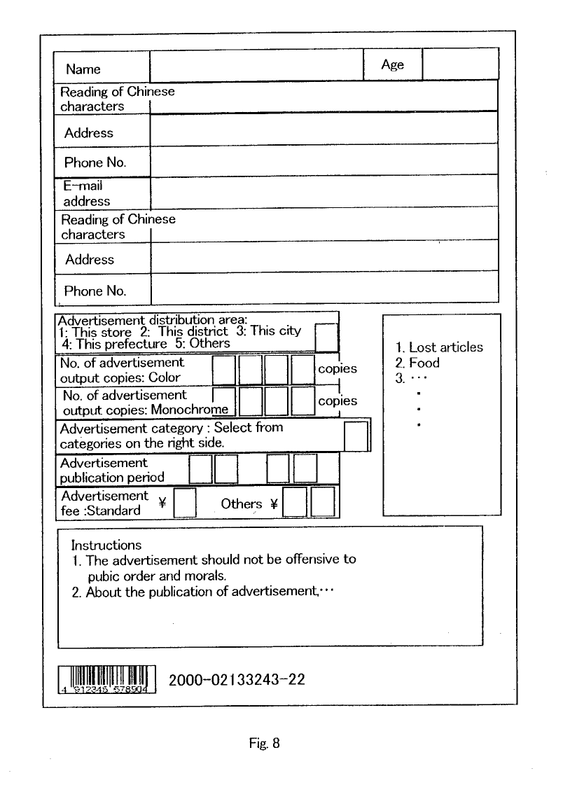

FIG. 8 shows an example of a column and a mark sheet provided in the area R1 on the form in which image information will be output, wherein the column and the mark sheet are areas for specifying attribute information. The example in the figure includes the fields for the following: information on the user who wants to register information such as the name, age, address, phone number, and electronic mail address, attribute information on the specific image information such as an advertisement distribution area, output selection between color and monochrome and the number of copies, advertisement category, advertisement publication period, and advertisement unit fee, and notice regarding this service.

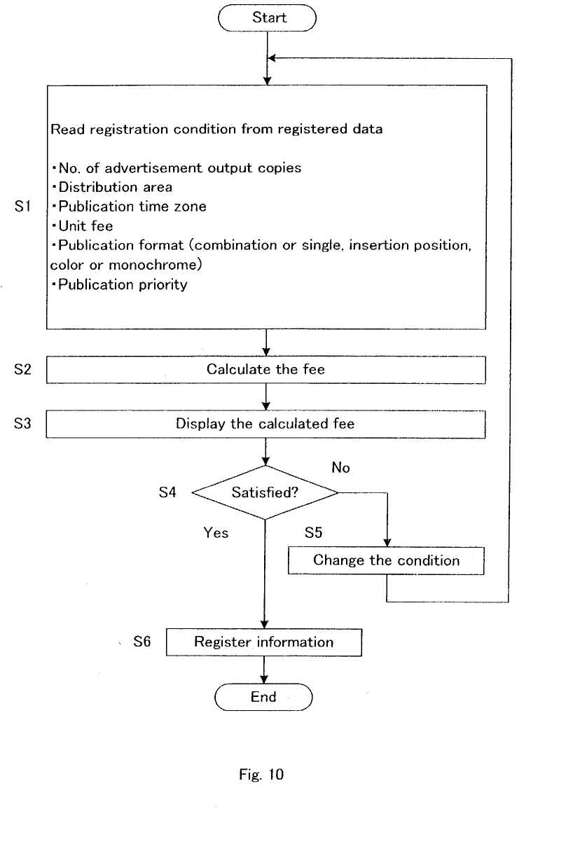

FIG. 10 shows a flowchart illustrating an example of the fee calculation procedure. In this calculation example, the registration condition is read from the registered data based on the attribute information (S1), and the fee required for registration is calculated based on this registration condition (S2). For example, the registration condition includes the number of advertisement output copies (may be set according to the output color such as color or monochrome), advertisement distribution area, advertisement publication time zone, output unit fee (may be set according to the output color selection such as color or monochrome), publication format, or publication priority. The publication format includes whether the advertisement is published singly or in a combination with other advertisements, advertisement insertion position, and output selection between color and monochrome. The publication priority may also be set to determine the priority of the publication of this advertisement.

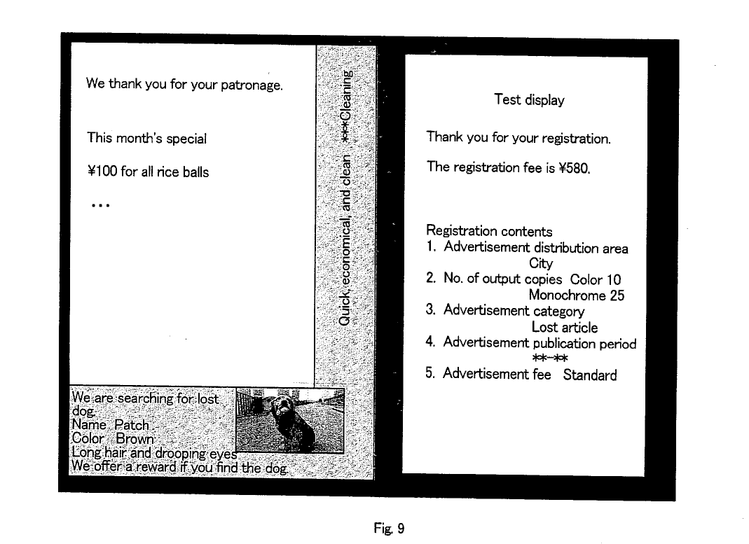

To calculate the fee based on the registration condition, the unit fee is set in advance for a combination of conditions and this unit fee is multiplied by the number of copies (S2) The calculated fee is displayed on the display unit (monitor and so on) at the cash desk (S3). FIG. 9 shows an example of the confirmation screen. This figure shows the preview screen in the left column, and the registration fee and the registration contents in the right column.

The user examines the preview screen and the calculated fee. If the user enters an instruction indicating that he or she is satisfied (S4), the information is registered (S6). If the user is not satisfied, the user is requested to change the condition (S5) and control is passed back to step S1 that is the first step.

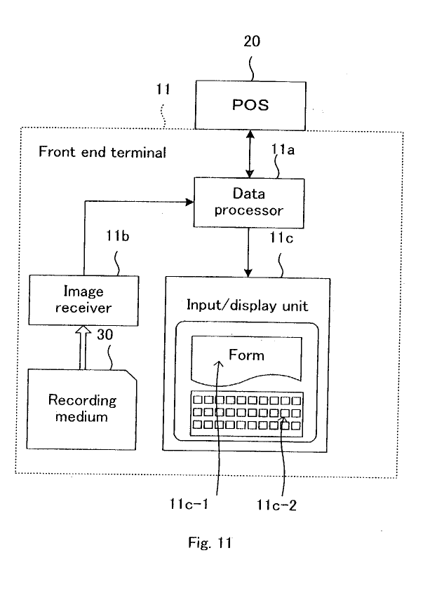

Next, with reference to FIGS. 11-19, the procedure for registration via a front end terminal and a dedicated registration terminal will be described.

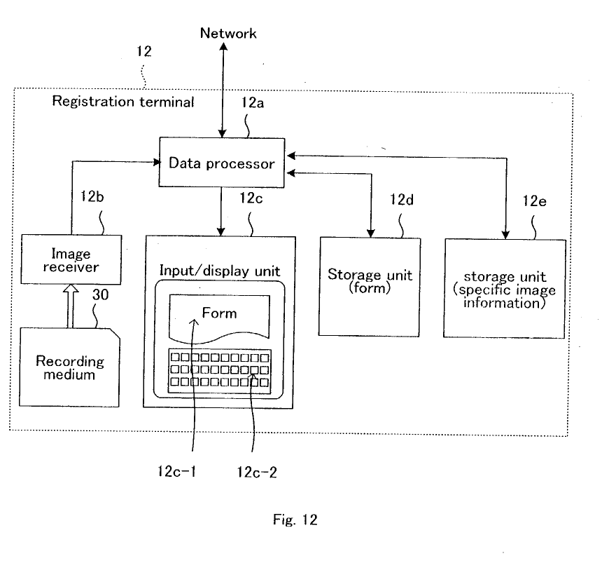

FIG. 11 shows an example of the configuration of a front end terminal, and FIG. 12 shows an example of the configuration of a registration terminal.

Referring to FIG. 11, the front end terminal 11, which comprises a data processor 11a, an image receiver 11b, and an input/display unit 11c, is connected to a POS system 20 in the front end. The input/display unit 11c displays a form 11c-1 on the display screen and, at the same time, receives attribute information from the display screen or from a keyboard 11c-2 separately provided.

The image receiver 11b, which is means for receiving image information of the specific image information, receives image data from a recording medium 30 such as a flexible disk, CD-ROM, or semiconductor memory. The image information of the specific image information may be captured not only from the recording medium 30 but also from the photographing unit of a digital camera that is mounted.

The processing for the user that is performed after the registration form is read by the front end scanner may also be done on the front end terminal 11.

Referring to FIG. 12, the registration terminal 12, which comprises a data processor 12a, an image receiver 12b, and an input/display unit 12c similar to those on the front end terminal 11 as well as storage units 12d and 12e, is connected to the network. The input/display unit 12c and the image receiver 12b may be the same as the input/display unit 11c and the image receiver 11b installed on the front end terminal 11. Because the registration terminal 12 is not connected directly to a POS system, the storage units 12d and 12e are provided to store received information. The storage unit 12d stores data on the forms, while the storage unit 12e stores specific image information (image information, attribute information)

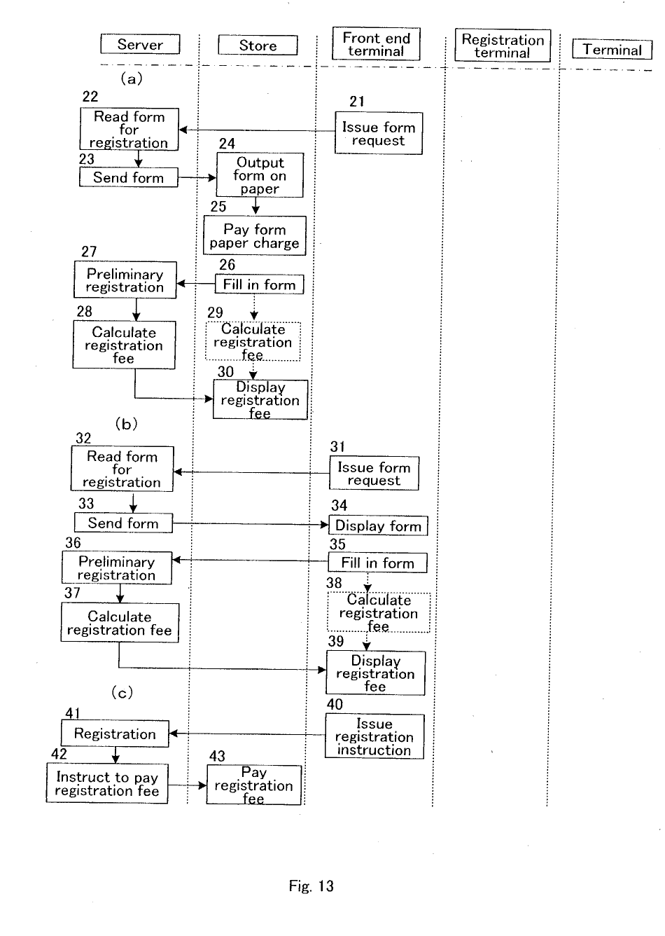

FIG. 13 shows how the signals are transferred between the server and the front end terminal.

FIG. 13(a) shows the procedure performed when a request for a form stored in the server is issued from the front end terminal, the form is output on the output unit at the store, and information is registered at the store. In response to a request for a form from the front end terminal (21), the server reads a predetermined form from the stored registration forms (22), and sends the form to the requesting store (23). The store outputs the received form on paper (24) and collects the form paper charge from the user who wants to register information (25).

The user who wants to register information fills in the obtained form with image information and attribute information and puts the form on the scanner at the cash desk in the store to feed it (26). The image that is read is checked if it is not offensive to public order and morals and, if it is not, sent to the server. The server performs preliminary registration based on the received specific image information (27), calculates the registration fee based on the attribute information, and sends the result to the store (28). The store displays this registration fee information (30). The calculation of the registration fee may also be done in the store (29).

FIG. 13(b) shows the procedure performed when a request for a form stored in the server is issued from a front end terminal, the form is output on the display unit at the front end terminal, and information is registered via the screen. In response to a request for a form from the front end terminal (31), the server reads a predetermined form from the stored registration forms (32) and sends the form to the requesting front end terminal (33). The front end terminal displays the received form on the screen (34).

The user fills in the obtained form with image information and attribute information on the screen and sends the form to the server (35). The server performs preliminary registration based on the specific image information specified on the received form (36), calculates the registration fee based on the attribute information, and sends the result to the store (37). The front end terminal displays this registration fee information (39). The calculation of the registration fee may also be done on the front end terminal (38). The image may be checked if it is not offensive to public order and morals at the server or on the display unit (monitor and so on) at the cash desk in the store.

FIG. 13(c) shows the procedure for paying a registration fee. The user who wants to register information views the registration fee displayed on the front end terminal and, if he or she is satisfied with the registration fee, issues a registration instruction (40). In response to the registration instruction, the server registers the information (41) and instructs the POS system in the store to pay the registration fee (42). The store collects the registration fee from the user who wants to register information, and the user pays the registration fee in the POS system (43).

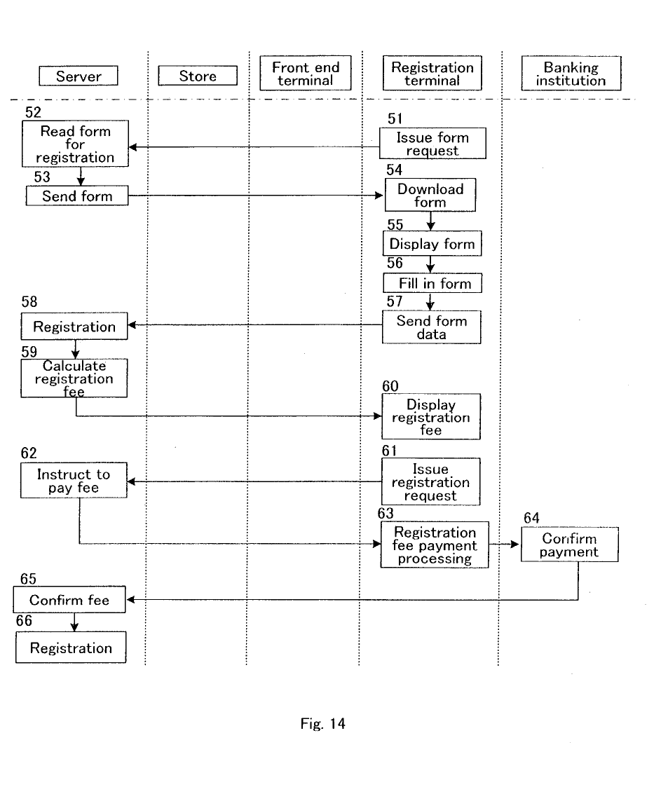

FIG. 14 shows the signals transferred between the server and a registration terminal.

When a request for a form entered by the user is sent from the registration terminal (51), the server reads a predetermined form from the stored registration forms (52) and sends the form to the requesting registration terminal (53). The registration terminal downloads the received form (54) and displays it on the screen (55). The attribute information is written in the form displayed on the registration terminal, the image information is entered (56), and the entered form data is sent to the server (57).

The server performs preliminary registration based on the received specific image information (58), calculates the registration fee based on the attribute information, and sends the result to the registration terminal (59). The registration terminal displays this registration fee information (60). The information maybe checked at the server if it is not offensive to public order and morals.

The user who wants to register information views the registration fee displayed on the registration terminal and, if he or she is satisfied with the registration fee, issues a registration request (61). In response to the registration request, the server registers the information and instructs the registration terminal to pay the registration fee (62). In response to the instruction, the registration terminal performs registration fee payment processing (63). The banking institution confirms the payment by the registration terminal and notifies the server that the payment is made (64). The server confirms the payment (65) and performs registration processing (66).

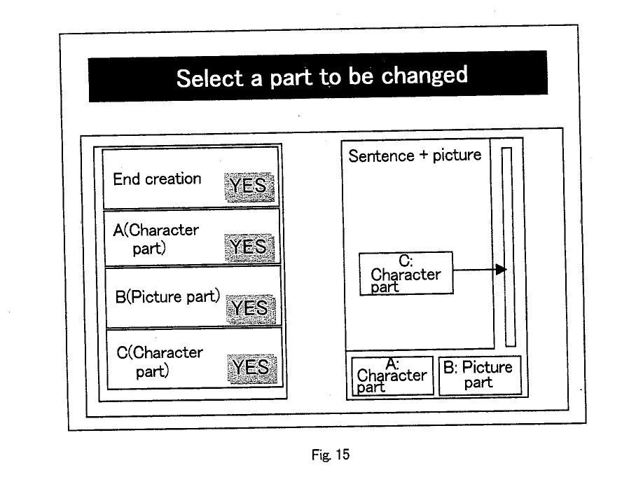

FIGS. 15-19 show some examples of form preparation on the terminal screen.

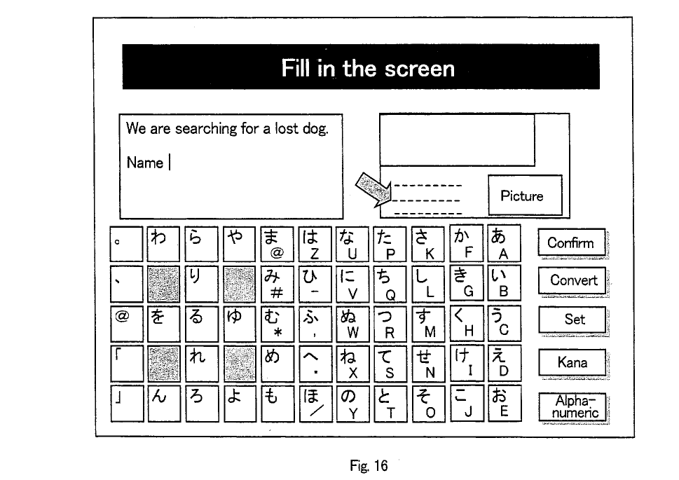

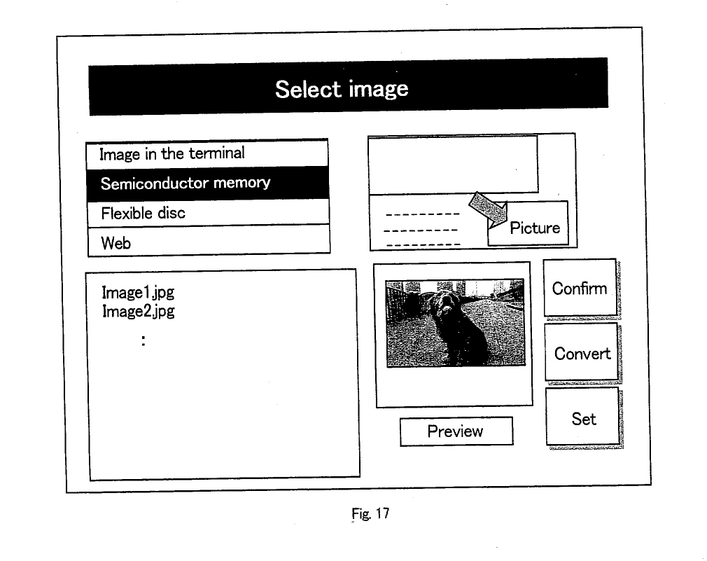

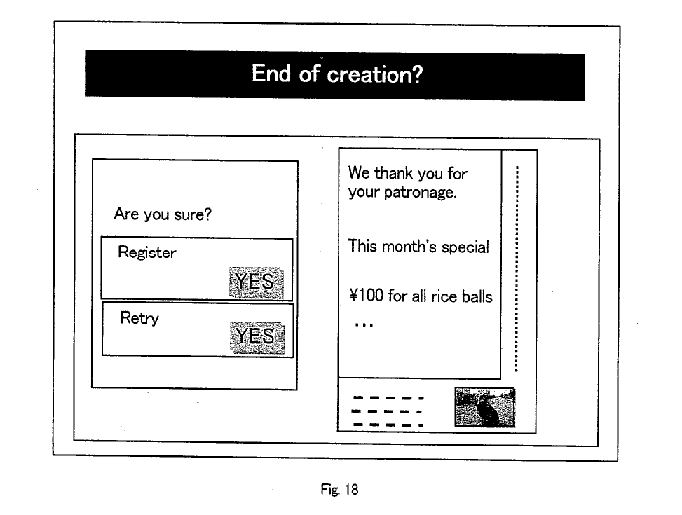

To enter an advertisement in the advertisement insertion part on the form on the terminal screen or to change an already-entered advertisement, the user selects, through the touch panel on the screen shown in FIG. 15, a part of the form to be filled in or changed. FIG. 16 shows an example of a soft keyboard (or dedicated keyboard) displayed on the screen after selection. FIG. 17 shows an example of the screen used to enter a desired image from the image source. On this screen, the user selects an image stored in the front end terminal or an image input source such as a flexible disk, CD-ROM, and semiconductor memory and so on. After registration is complete, the preview screen indicating the actual output screen is displayed (FIG. 18).

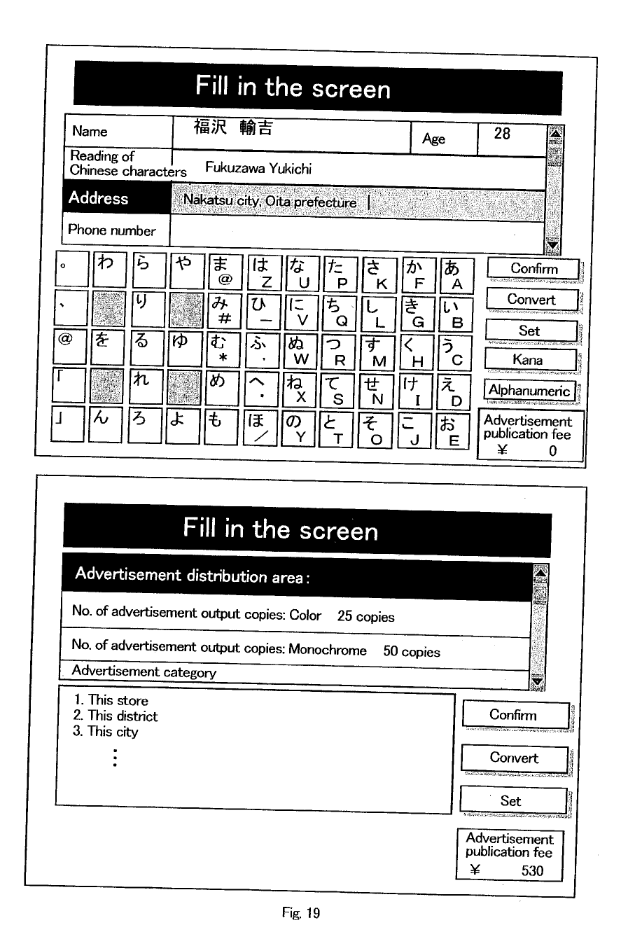

To enter attribute information, the user enters the name, address, phone number, and electronic mail address from the keyboard for registration as shown in FIG. 19. The user also selects the advertisement distribution area, the number of copies, advertisement category, advertisement publication period, and advertisement fee per copy. Then, the advertisement publication fee is displayed and, after the user confirms the fee, the data is sent to the POS.

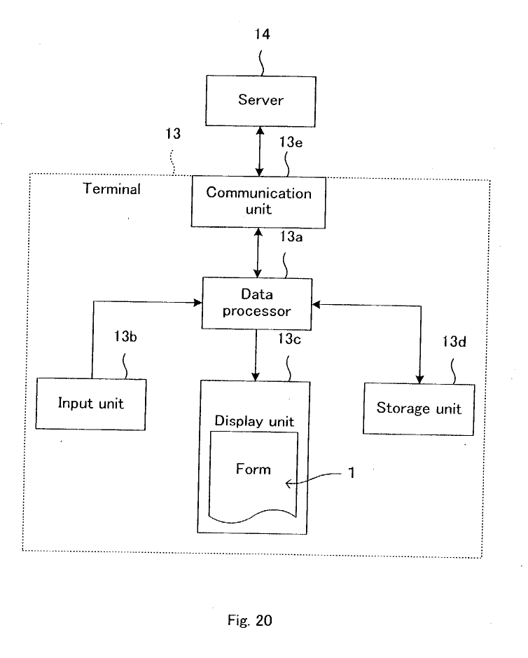

Next, with reference to FIGS. 20-25, the procedure for registration over a network will be described.

Referring to FIG. 20, the terminal 13, typically a personal computer at home, comprises a data processor 13a implemented by the CPU, an input unit 13b, a display unit 13c, and a storage unit 13d. The terminal is connected to the server 14 via a communication unit 13e and a network.

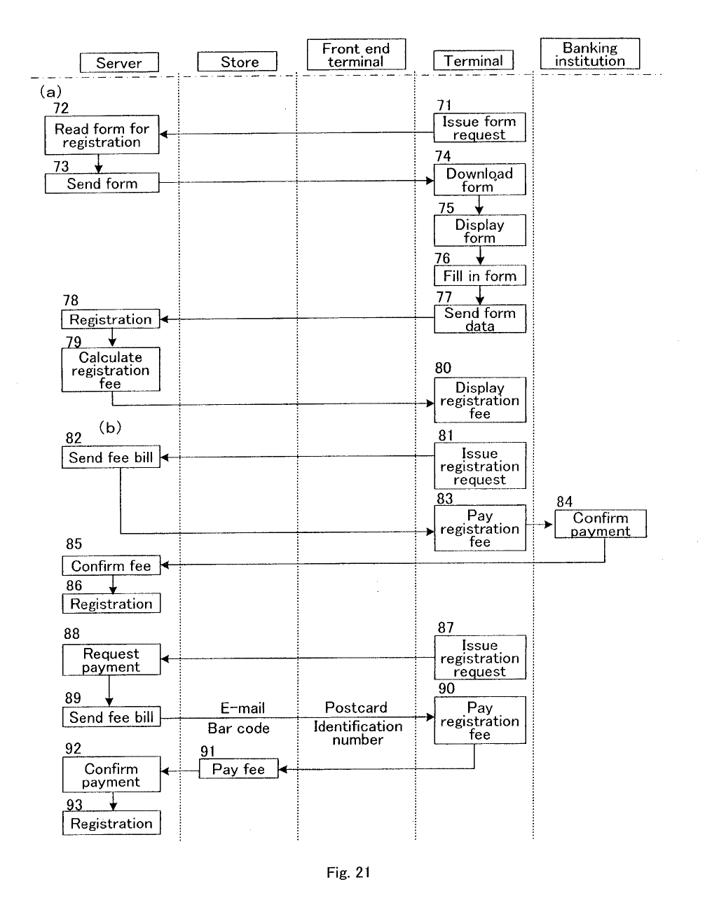

FIG. 21 shows the signals transferred between the server and the terminal.

In response to a request for a form entered by the user at the terminal (71), the server reads a predetermined form from the stored forms (72) and sends the form to the requesting registration terminal (73). The terminal downloads the received form (74) and displays the form on the screen (75). On the terminal, the user writes an advertisement (image information) in the specific image information area which is included in the form displayed on the screen and in which the advertisement is to be inserted and, at the same time, enters attribute information separately (76). The entered form data is sent to the server (77).

The server performs preliminary registration based on the received specific image information and attaches an advertisement publication code (78). Then, the server calculates the registration fee based on the attribute information and sends the result to the terminal (79). The terminal displays this registration fee (80). The server checks if the information is not offensive to public order and morals. If there is no moral problem, the advertisement publication code is sent via electronic mail; on the other hand, if there is a moral problem, an electronic mail indicating the problem is sent.

FIG. 21(b) shows an example of registration processing in which payment is made via a credit card on the web. When a registration request is issued from the terminal (81), the server receives this request and sends a registration fee payment instruction to the terminal (82). Upon receiving this registration fee payment instruction, the terminal performs payment processing with the banking institution via a credit card on the web (83). When the banking institution confirms the payment (84), the server receives the payment confirmation from the banking institution (85) and performs registration processing (86).

The advertisement is confirmed among the terminal, banking institution, and server using the advertisement publication code.

FIG. 21(c) shows another example of registration processing in which the registration fee is paid at the store. In response to a registration request from the terminal (87), the server receives this request (88) and sends the registration fee bill with sending means such as an electronic mail or a postcard. In this case, the advertisement is specified by the bar code to which the advertisement publication code is attached or by the identification number (89). The terminal receives this registration fee bill (90). The user pays the bill using the bar code or the identification number at the store (91). Upon recognizing the payment at the store (92), the server performs registration processing (93). When the payment of the advertisement publication fee is completed via a credit card on the web or by entering the advertisement publication code from the cash register, the server starts publication advertisement processing as soon as it confirms the payment.

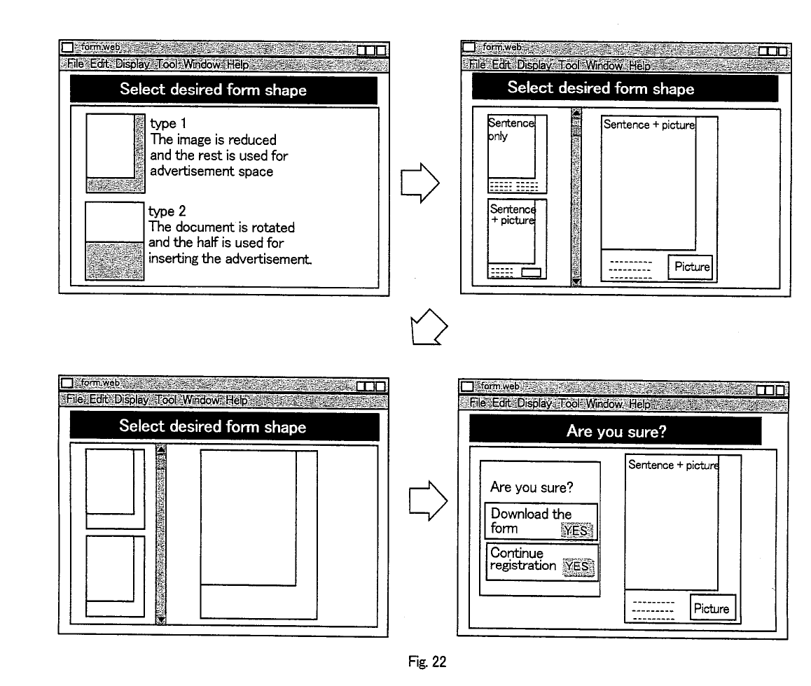

FIGS. 22-25 shows some examples of form preparation using a web.

FIG. 22 shows the operation performed when a form is downloaded from a server (web site) that publicizes the form. This operation is similar to the operation shown in FIG. 6. That is, in FIG. 22, the form shape patterns are first displayed for the user to select a desired one. Then, the user is requested to select one of two patterns of specific image information to be registered using the selected shape pattern: a pattern composed of sentences only and a pattern composed of a combination of sentences and pictures. After the shape pattern is selected, the user is requested to select the pattern (background) of the form. After the selections are completed, the user selects whether to download the form or to continue work.

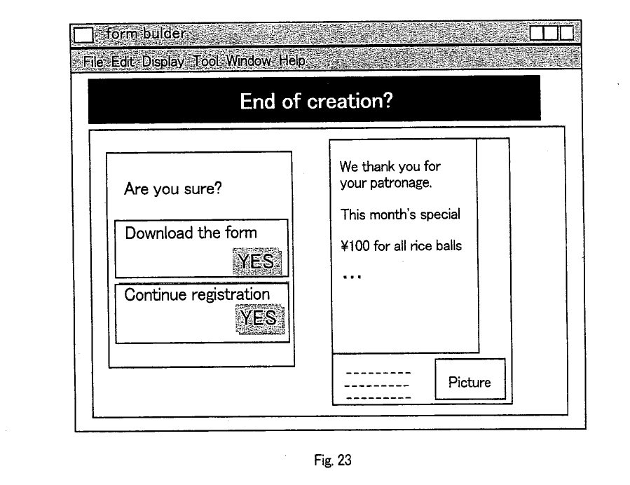

FIG. 23 shows the preview screen indicating the actual display that is displayed after registration ends.

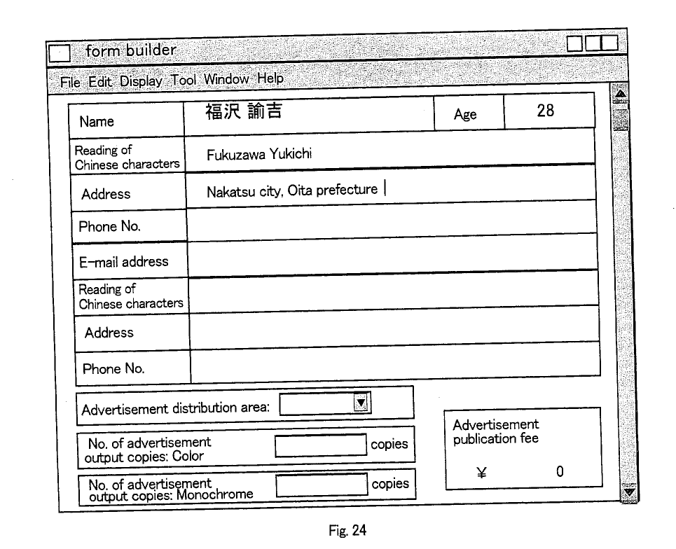

FIG. 24 shows an example of attribute information that is entered. The screen is designed to allow the user to enter the name, address, phone number, and electronic mail address from the keyboard and to select the advertisement distribution area, number of copies, advertisement category, advertisement publication period, and advertisement fee per copy. The calculated advertisement publication fee may also be displayed.

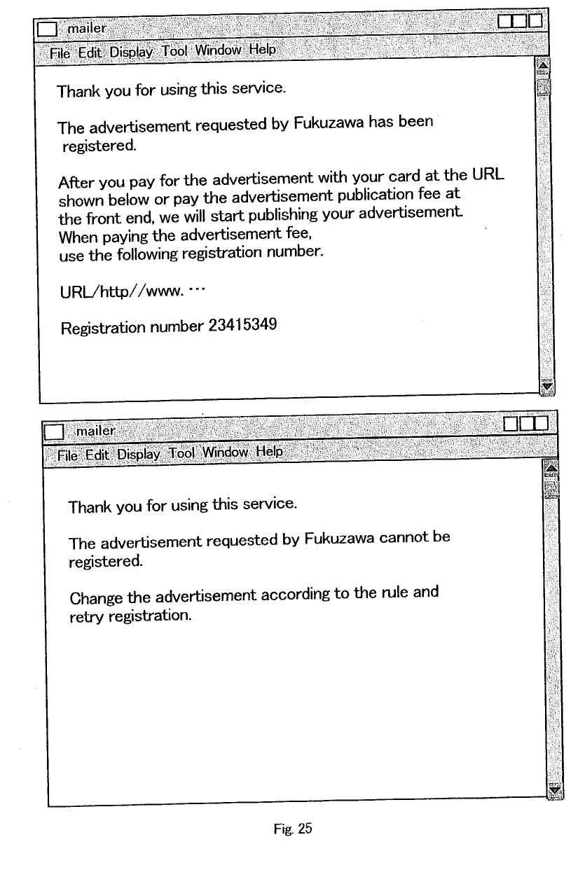

FIG. 25 shows an example of display after registration. In this example, advertisement data is registered with a web site that is set up for advertisement registration. After registration, the web site manager checks if the information is not offensive to public order and morals and, if there is no problem with advertisement publication, delivers the advertisement publication code to the advertiser via electronic mail as shown in the example of the screen in the top of FIG. 25. If there is a problem, the manager delivers an electronic mail to the advertiser indicating that there is a problem with the registration contents, as shown in the example of the screen in the bottom of FIG. 25.

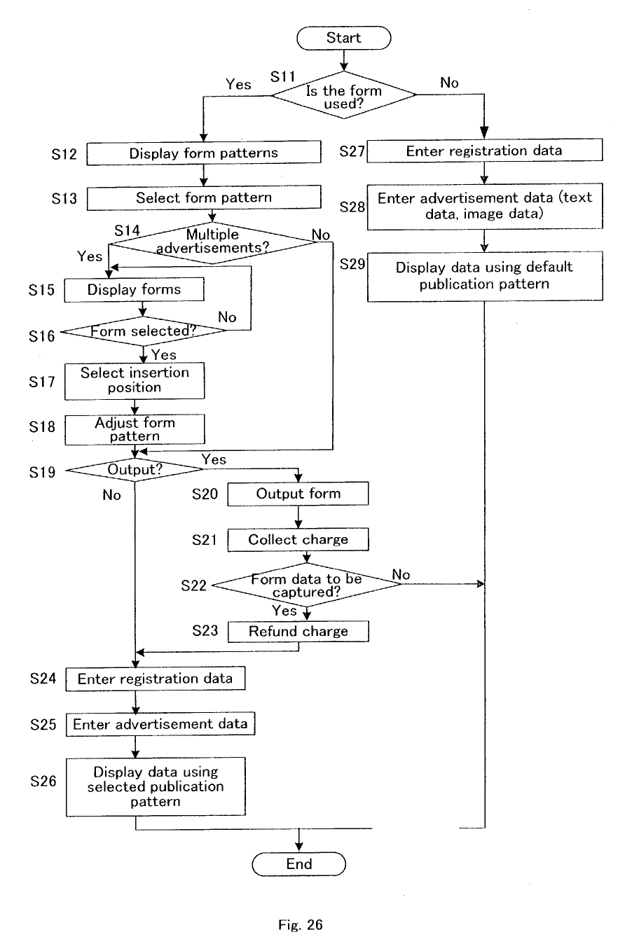

Next, with reference to the flowchart in FIG. 26, the procedure for publishing an advertisement at a web site will be described.

When an advertisement is to be published using a form (S11), a plurality of form patterns are displayed (S12). The user selects a desired form pattern (S13).

When the selected form pattern is a pattern that is a combination of a plurality of advertisements (S14), form patterns are displayed (S15) to allow the user to select a combination of desired patterns (S16). The user is required to specify where, in the selected pattern, to insert the advertisement to be published (S17) and, at the same time, to combine the pattern (background) and the shape of the form with other advertisement parts (S18).

After selecting a form from a plurality of patterns in steps S15-S18 or after selecting in step S14 to publish the advertisement by itself, the user selects whether the selected form is to be output on paper or on the screen (S19).

When the form is to be output on paper (S19), the selected form is output on paper (S20) and the output charge is collected (S21). If the user fills in the output form with specific image information and captures form data (S22), the form output charge is refunded (S23).

Using the form that is output on paper or displayed on the screen, registration data (attribute information) and advertisement data (image information) are entered based on the specific image information written on the form (S24, 25) and the entered data is displayed using the selected publication pattern (S26).

When the user selects in step S11 to publish the advertisement without using a form, the user enters registration data (attribute information) directly (S27) and enters advertisement data (image information (character data, image data) ) (S28). The entered data is displayed using the pre-set default publication pattern (S29).

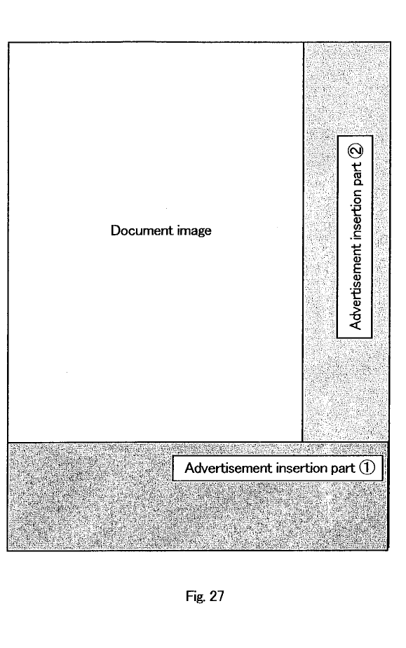

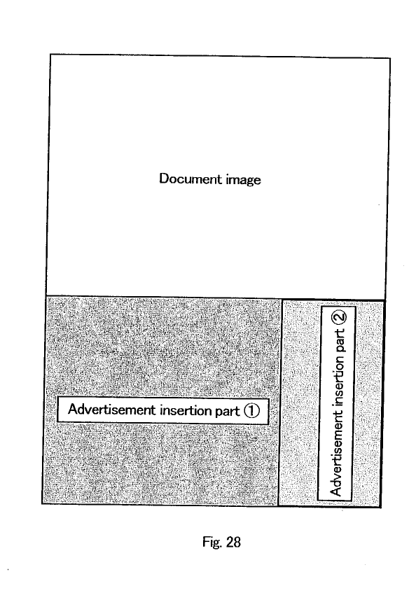

FIGS. 27 and 28 show an example of an advertisement form in this embodiment. FIG. 27 shows a form where a document image is reduced with an advertisement image placed in the blank space that has the first and second advertisement insertion parts. FIG. 28 shows a form where a document image is reduced and rotated with the advertisement image placed in the blank space.

In FIGS. 27 and 28, the image output area is divided into the area where document image information is output and the area where specific image information such as advertisement information is output. The specific image information are is further divided into advertisement insertion parts \mathring{1} and \mathring{2} to allow a plurality of advertisements to be inserted.

The mark sheet includes a selection item that asks the advertiser whether multiple advertisements may be inserted. If the user does not permit the insertion of multiple advertisements, the user's advertisement is inserted in the whole advertisement insertion range. On the other hand, if the user permits the insertion of multiple advertisements, the advertiser selects one of advertisement insertion parts \mathring{1} and \mathring{2} in FIGS. 27 and 28 to insert the advertisement in the selected advertisement insertion part. The unselected advertisement insertion part allows another advertiser to insert an advertisement. The advertisement fee is determined depending upon the selected advertisement insertion part. Dividing the advertisement insertion part as described above reduces the advertisement publication fee.

Alternatively, it is possible that a form is provided to the advertiser with the advertisement of a contracted company already placed in one of the advertisement insertion parts. This type of form allows the advertisement to be directed to the user who wants to register information.

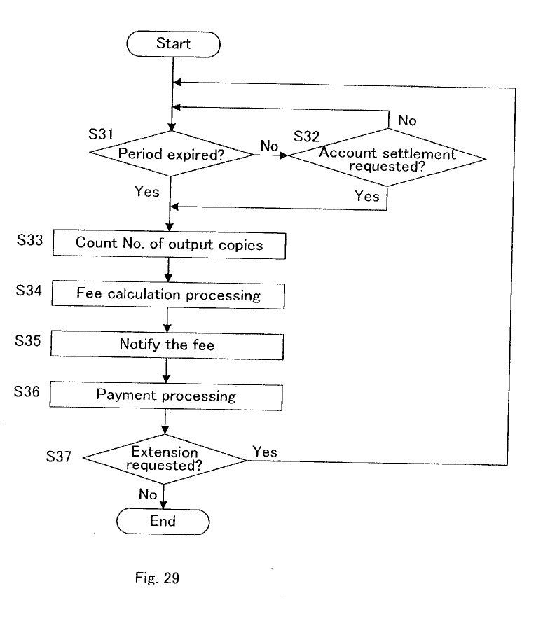

The registration fee may be determined not only at a registration time but also according to the number of output copies. The flowchart in FIG. 29 shows a system in which the fee is determined according to the number of output copies, that is, a so-called fee-for-service system.

In this case, the output period is determined in advance and, if an account settlement request is issued (S32) during this period (S31) or if the period has expired, the number of copies actually output is counted (S33) and the fee is calculated based on the number of output copies (S34). The calculated fee is sent to the advertiser via electronic mail (S35) and the payment processing is performed (S36). If the advertiser issues an extension request (S37), the publication is continued.

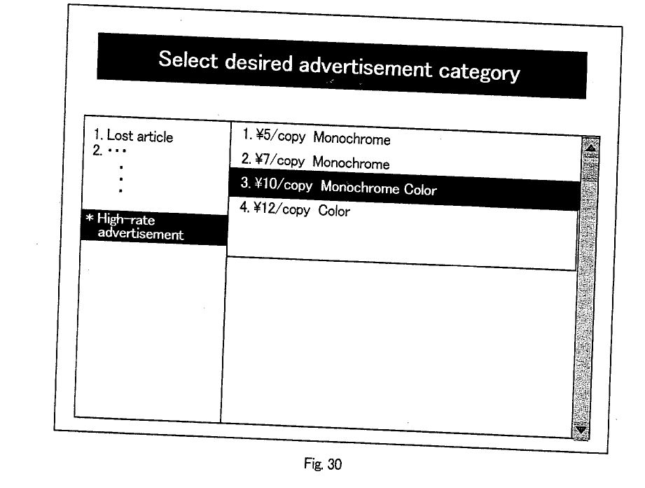

The advertisement registration fee, usually calculated based on such factors as the number of advertisement output copies, color or monochrome selection, advertisement publication range, and advertisement fee per copy, may also be calculated based on other optional factors. For example, with the standard advertisement fee per copy written on the form, another fee may also be shown to allow the user to select an option. More specifically, the fee of an advertisement required to attract more attention and sooner is set high. FIG. 30 shows an example of this selection screen. If, when advertisement information is output with document image information, the user agrees with the output of advertisement information for which a higher advertisement fee is set, the amount corresponding to the advertisement fee is reduced from the image output charge. Because the reduction amount of a high-rate advertisement is large, more copy service users will use this option.

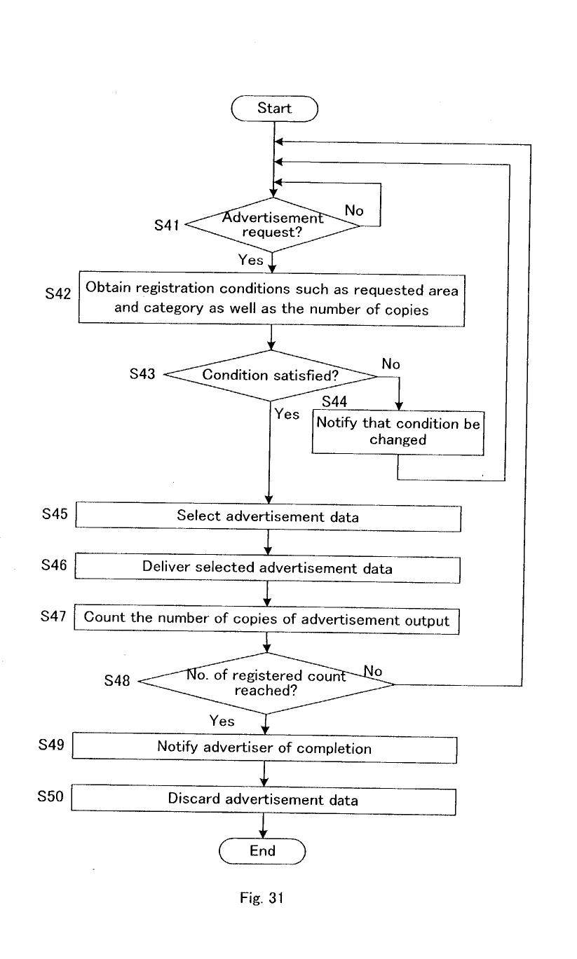

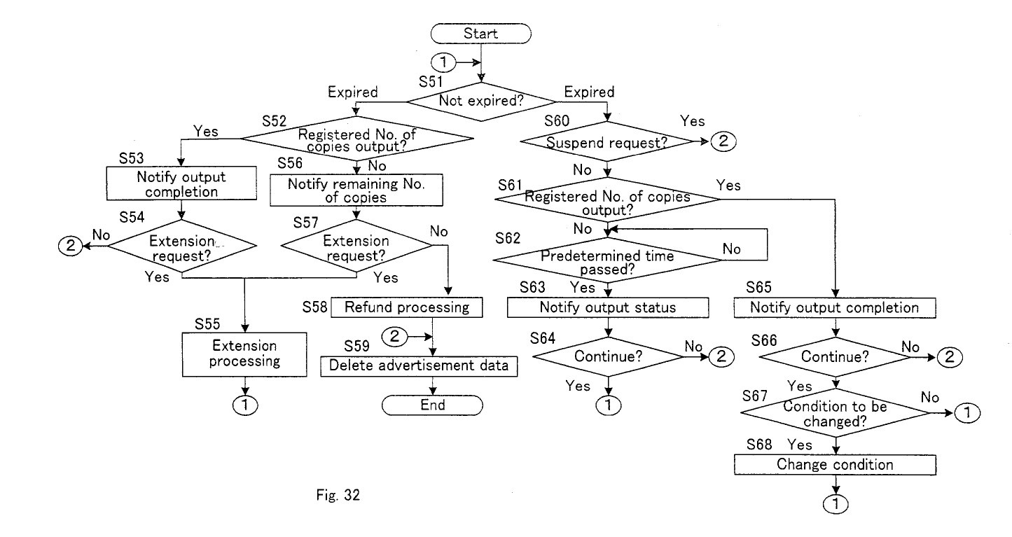

Next, with reference to FIGS. 31 and 32, the operation of the server will be described.

FIG. 31 is a flowchart showing an example of advertisement output management performed by the server. In response to an advertisement publication request from an image processor installed in a store (S41), the server obtains the registration conditions (S42) such as the area where the requesting image processor is installed and the selected category as well as the number of copies and checks if an advertisement satisfying the obtained conditions is registered (S43). If there is no advertisement satisfying the conditions, the server sends a notification to the store, where the requesting image processor is installed, to request that the conditions be changed (S44).

If there are advertisements satisfying the conditions (S43), the server selects advertisement data to be output. The selection of advertisements may be made either randomly from advertisements satisfying the conditions or based on a predetermined condition. For example, if there are several advertisements satisfying the conditions, one of them is selected according to the priority or two or more advertisements are combined for a request for the output of multiple copies (S45).

The server delivers selected advertisement data to the image processor (S46) and counts the number of copies of advertisement output (S47). When the accumulated number of copies of advertisement output reaches the registered number of output copies (S48), the server notifies the advertiser that the advertisement output is completed (S49) and discards the advertisement data (S50).

The flowchart in FIG. 32 shows the management operation performed by the server for each advertisement. This processing may be performed regularly (for example, once a day).

The server checks each registered advertisement if the registered period has expired (S51). If the period has expired, the server checks if the number of copies has reached the registered number of copies (S52). If the registered number of copies have been output, the server issues an output completion notification (S53). If a period extension request is issued (S54), the server extends processing (S55); if a period extension request is not issued, the server deletes advertisement data (S59).

If the registered number of copies have not yet been output, the server notifies the registrant of the remaining number of copies (S56). If a period extension request is issued (S57), the server extends the processing (S56); if a period extension request is not issued (S57), the server refunds the fee (S58) and deletes the advertisement data (S59).

On the other hand, if the period has not yet expired (S51) and if a suspension request is issued (S60), the server deletes the advertisement data (S59); if a suspension request is not issued (S60), the server checks if the registered number of copies have been output (S61).

If the registered number of copies have not yet been output, the server issues an output status notification (S63) after a predetermined time has passed or at a predetermined time (S62) and asks the registrant whether to continue publishing the advertisement (S64). If the registrant does not want to continue the publication of the advertisement, the server deletes the advertisement data (S59).

On the other hand, if the registered number of copies have been output (S61), the server issues an output completion notification (S65) and asks the registrant whether to continue the publication of the advertisement (S66). If the registrant does not want to continue the publication of the advertisement, the server deletes the advertisement data (S59); if the registrant wants to continue the publication of the advertisement (S66), the server checks if a condition change request is issued (S67) and, if such a request is issued, changes the conditions (S68).

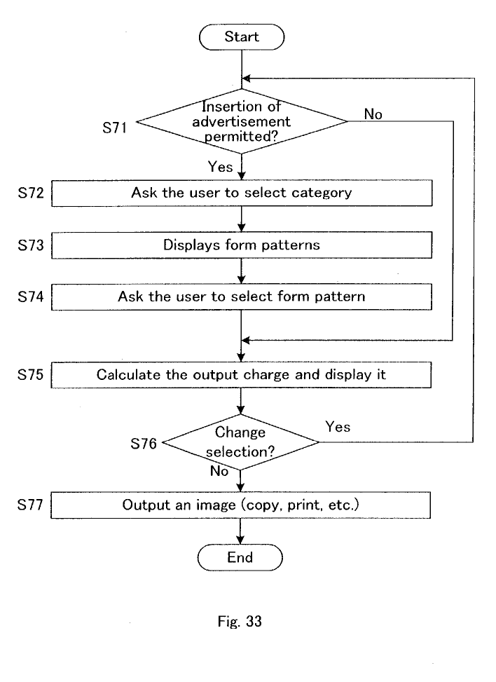

Next, with reference to the flowchart in FIG. 33, the operation of an image processor when the user outputs document image information as an image will be described.

When the user uses an image processor to output an image, the image processor asks the user if an advertisement is to be displayed on the screen. If the user permits the image process or to insert an advertisement (S71), the image processor asks the user to select a permissible advertisement category (S72) and displays the form patterns (S73) to allow the user to select one of them (S74).

The image processor calculates the charge of an image output in which the advertisement will be inserted and displays the charge (S75). If the user does not change the selection (S76), the image processor outputs the image (copy, print, etc.) (S77).

If the user does not permit the insertion of an advertisement in step S71, the image processor calculates the charge of an image output in which an advertisement will not be inserted and displays the charge. In this case, the image processor may also calculate the charge of an image output in which an advertisement will be inserted and displays both charges to allow the user to compare between them.

If the user requests to change the selection in step S76, control is passed back to step S71 to restart processing.

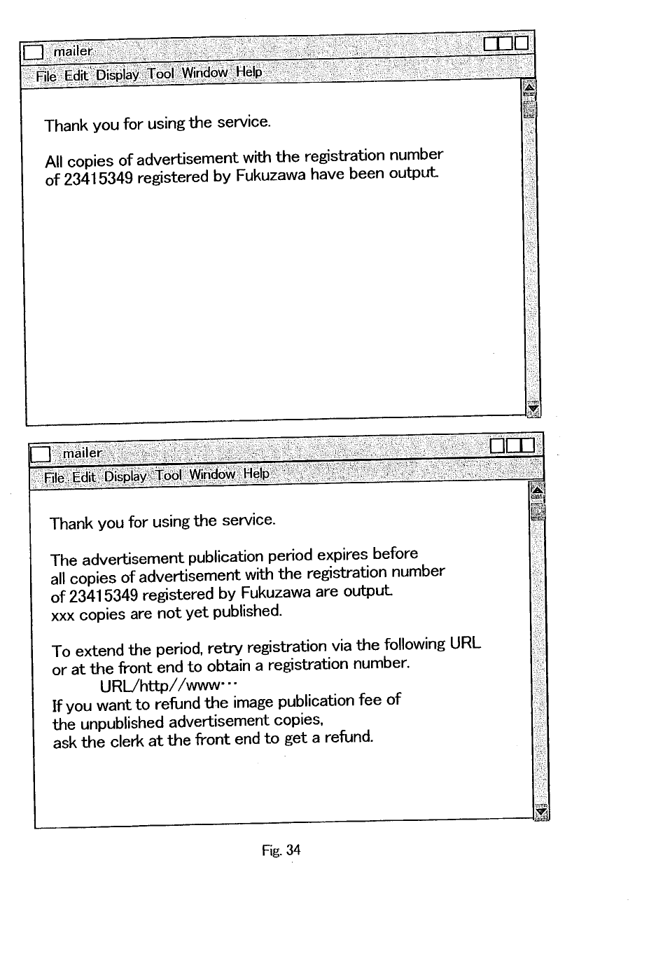

The following describes processing that is performed after an advertisement is published. When the advertisement publication fee is paid in advance, all copies are not output in some cases and, in such a case, the load on the advertiser increases. To solve this problem, the advertisement management side notifies the advertiser of the advertisement publication status via an electronic mail or a postcard after the advertisement publication period expires or when all copies of the advertisement are output. FIG. 34 shows an example of notification. This example shows two cases; that is, all copies have been published (top in FIG. 34) and all copies are not output but some remains unpublished (bottom in FIG. 34). After sending the latter notification, the management side determines whether to extend the period for continued publication or to refund the advertisement publication fee; then, the management side sends a notification via an electronic mail or refunds the advertisement publication fee at the front end. At this time, the management side checks the identification number or advertisement publication code attached to the electronic mail or checks the bar code, identification number, or advertisement publication code attached to the postcard, to refund the advertisement publication fee at the front end or registers the advertisement again at the web. This eliminates wasteful advertisements.

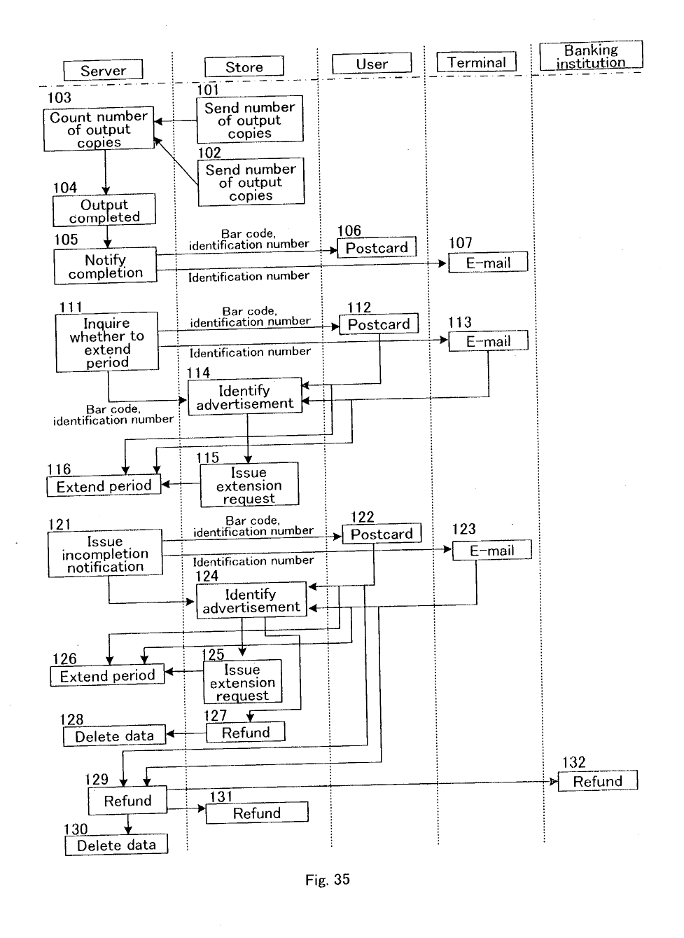

FIG. 35 is a sequence diagram of the processing performed after an advertisement is published.

Each store sends to the server the number of copies output by the information processor installed at the store (101, 102). The server counts the number of output copies, sent from each store, for use in management. The number of output copies is counted and managed for each advertisement (103). When the number of output copies of an advertisement that is managed has reached the registered number of copies (104), the server informs the user of output completion (105). To notify the user of output completion, the server sends to the user a postcard with the bar code or identification number (106) or sends to the terminal an electronic mail with the identification number (107).

To inquire whether to extend the period, the server sends to the user a postcard with the bar code or identification number (112) or sends to the terminal an electronic mail with the identification number (113). The store checks the bar code or identification number to identify the registered advertisement to which the period extension inquiry has been sent from the server. When the user requests to extend the period, the store identifies the request with the bar code or identification number (114) and issues an extension request to the server (115). In response to the extension request from the store, the server extends the period. The server may also extend the period in response to a period extension request from the user (116).

If the period expires before the output is not yet completed, the server sends to the user a postcard with the bar code or the identification number (122), or to the terminal an electronic mail with the identification number (123), to notify the user of uncompleted output. The store checks the bar code or the identification number to identify the advertisement to which an incompletion notification has been sent from the server. When a period extension request is issued from the user, the store identifies the advertisement with the bar code or the identification number (124) and issues an extension request to the server (125). In response to the extension request from the store, the server extends the period (126). The server may also extend the period in response to a request from the user.

When the store receives a refund request from the user, the store identifies the advertisement with the bar code or identification number (124) to do refund processing (127). In response, the server deletes the advertisement data (128).

When the server receives a refund request from the user via an electronic mail and so on, the server identifies the advertisement with the identification number (129), deletes the advertisement data (130), and asks the store or the banking institution to do refund processing (131) (132).

Although the preferred embodiments of the present invention have been described, various changes and modifications may be done to the system described above. For example, although the registrant in the above description is mainly an individual, an organization such as a corporate or an organization may also use the system. In addition, although the specific image information to be distributed is an advertisement in the above description, it is not limited to an advertisement. Although the configuration of the system is such that the server is used over a network, the present invention may also be implemented locally in a store where the copy services are provided. The store and the front end terminal, though separate in the above description, may also be integrated. In such a case, the duplicated components need not be installed.

As described above, the present invention allows specific image information to be distributed (published) easily, simply, and economically.

In particular, specific image information to be distributed may be created and registered in a store or on a web and, when the copier or printer services are provided in the store, document image information as well as the registered specific image information is output to provide the local users, who visit the store, with the specific image information.

The service provider gets paid for the registration of specific image information, while a service user, who has specific image information added to his or her document image information, receives a discount benefit from using the system.

A person who wants to distribute specific image information is able to enter information by handwriting or via a terminal at the front end, meaning that specific image information may be registered without electronic devices such as a PC or FAX. Registration at a front end makes it possible to instantly check if the information is not offensive to public order and morals and to collect the registration fee. After being registered, the specific image information may be distributed very soon.

The mark sheet entry method, if used during registration via handwriting, allows the user to register information easily and speeds up subsequent processing required to register specific image information.

By using a form for specific image information, patterns may be developed for how specific image information will be inserted. This enables the user who wants to register information to easily understand how the information will be inserted. It is possible to vary the registration fee depending upon the pattern that is used. If the charge is collected for form output, all or a part of the charge required for output may be refunded to the registrant when registering information using the form. This gives the user an urge to use the form.

Registering specific image information using a web eliminates the need to visit a store.

Parts of a form where specific image information will be inserted may be individually selected, with the registration fee varying according to the part. This reduces the registration fee the user must pay.

The user can specify in advance the number of copies to be output for specific image information to determine the range of distribution and to estimate in advance the total cost required for distributing the specific image information. A registration period, if specified, limits the period during which the specific image information will be distributed. If the number of copies that has been output after the period expires does not reach the predetermined number of copies, the period may be extended or the advertisement publication fee may be refunded. This makes the service easier for the user to use.

What is claimed is:

1. An image processing method for outputting document image information, comprising the steps of:
image-processing the document image information and pre-registered specific image information; and
outputting the image-processed document image information and specific image information into respective areas prepared on the same surface therefor.

2. An image information processing method for performing image-combining and/or image-editing processing for document image information and registered specific image information for outputting the information as images,
wherein image information and attribute information of the specific image information are registered using a form with a specific format.

3. The information processing method according to claim 2, wherein the image information of the specific image information includes image data and/or character data.

4. The information processing method according to claim 2, wherein a fee required for registration is calculated using the attribute information of the specific image information described on the form.

5. The information processing method according to claim 2, wherein the attribute information includes output mode information on the specific image information, and wherein, based on the output mode information, an output mode is set and a fee required for registration is calculated.

6. The information processing method according to claim 2, wherein the form has a plurality of areas for registering the image information of the specific image information, and wherein a fee required for registration is calculated according to an area in which the image information of the specific image information is to be inserted, said area being one of said plurality of areas.

7. The information processing method according to claim 4, wherein at least part of the calculated fee required for registration is reduced from a charge required for outputting an image, said charge being collected from a person who outputs the image.

8. The information processing method according to claim 6, wherein said form has a bar code or an identification number attached for identifying the form and
wherein the plurality of patterns and shapes of forms to be set in said plurality of areas are identified using the bar code or the identification number.

9. The information processing method according to claim 2, wherein the attribute information is obtained from image data read from an image reading unit.

10. The information processing method according to claim 9, wherein said image reading unit has an OCR (Optical Character Recognition) function to read the attribute information described using a mark sheet.

11. The information processing method according to claim 2, wherein the attribute information includes at least one of a number of image output copies, image distribution area, category to which the specific image information belongs, output processing period, and output image color information.

12. The information processing method according to claim 2, wherein the form is obtained from a server for output as an image.

13. The information processing method according to claim 2, wherein, when the form is registered, at least part of an output charge of the form is refunded.

14. The information processing method according to claim 2, wherein a charge required for outputting an image of the document image information not including the specific image information is different from a charge required for outputting an image of the document image information including the specific image information.

15. The information processing method according to claim 4, wherein at least the attribute information of the form is sent to a POS system and
wherein, in said POS system, the fee required for registration is displayed and the attribute information is changed.

16. The information processing method according to claim 15, wherein at least the attribute information described on the form is sent to the POS system and
wherein said POS system receives the fee required for registration calculated based on the attribute information.

17. The information processing method according to claim 4, wherein a POS system is connected to a server via a network,
wherein said server sends registration information, which is registered via the network using the form, to a user by electronic mail or postcard to which identification information identifying the registration information is attached, and
wherein said POS system receives a fee for registering the image information from the user based on an attached bar code and/or an identification number.

18. The information processing method according to claim 4, wherein a POS system is connected to a server via a network, and
wherein said server counts a number of output copies of the registered image information, outputs a number of image copies registered by the attribute information, and notifies a user by electronic mail or postcard that the output of the image has been terminated.

19. The information processing method according to claim 4, wherein a POS system is connected to a server via a network, and
wherein said server counts a number of output copies of the registered image information and, when an output period registered in the attribute information expires before a number of output copies registered in the attribute information are output, notifies a user of the number of output copies by electronic mail or postcard to which identification identifying the registered information is attached, and
wherein, if the output period is to be extended in response to an instruction from the user, the POS system or the server on the network extends the registration identified by the identification information.

20. The information processing method according to claim 4, wherein a POS system is connected to a server via a network, and
wherein said server counts a number of output copies of the registered image information and, when an output period registered in the attribute information expires before a number of output copies registered in the attribute information are output, notifies a user of the number of output copies by electronic mail or postcard to which identification identifying the registered information is attached, and
wherein said POS system refunds a remainder of the fee of the registration identified by the identification information.

21. The information processing method according to claim 1, wherein the image processing is copy processing in which a document image is copied for output or output processing in which received image data is output.

22. An information processor that image-processes document image information and pre-registered specific image information for outputting the information, wherein the document image information and the specific image information are output into respective areas prepared on the same surface therefor.

23. An information processor that performs image-combining and/or image-editing processing for document image information and registered specific image information for outputting the information as images, comprising:
a registration unit that registers image information and attribute information of the specific image information described on a form with a specific format.

24. The information processor according to claim 23, wherein the image information of the specific image information includes image data and/or character data.

25. The information processor according to claim 23, further comprising a fee calculation unit that calculates a fee required for registration using the attribute information of the specific image information described on the form.

26. The information processor according to claim 23, wherein the attribute information includes output mode information on the specific image information,
wherein said registration unit sets an output mode based on the output mode information, and
wherein said calculation unit calculates a fee required for registration based on the output mode information.

27. The information processor according to claim 23, wherein the form has a plurality of areas for registering the image information of the specific image information and
wherein said calculation unit calculates a fee required for registration according to an area in which the image information of the specific image information is to be inserted, said area being one of said plurality of areas.

28. The information processor according to claim 27, wherein said form has a bar code or an identification number attached for identifying the form and
wherein said registration unit identifies the plurality of patterns and shapes of forms to be set in said plurality of areas using the bar code or the identification number.

29. The information processor according to claim 23, wherein the attribute information includes at least one of a number of image output copies, image distribution area, category to which the specific image information belongs, and output processing period.

30. The information processor according to claim 22, wherein said information processor is a copier or an output unit that outputs received image data.

31. An information processing system that connects, via a network,
an information processor that image-processes document image information and pre-registered specific image information for outputting the information, wherein the document image information and the specific image information are output into respective areas prepared on the same surface therefor;
a server that has a form with a particular format for describing image information and attribute information of the specific image information; and
terminals,
wherein said information processor obtains the image information and the attribute information of the specific image information via the form sent from said terminals via said server.

32. The information processing system according to claim 31, wherein said server uses the received form to register the image information and the attribute information of the specific image information, calculates a fee required for the registration, and displays the fee on said information processor.

33. The information processing system according to claim 31, wherein said server counts a number of output copies of the registered image information, outputs images up to a number of output copies registered in the attribute information, and informs a user by electronic mail or postcard that the output of the images has been terminated.

34. A form that with a format in which a recording area is divided into a first area that is a recording area of document image information during recording and a second area that is a recording area of specific image information during recording, wherein attribute information of the specific image information is included in said first area and image information of the specific image information is included in said second area.

35. The form according to claim 34, wherein said second area has a plurality of divided areas, and wherein the attribute information in said first area is attribute information on one of the image information in said divided areas.

36. The form according to claim 34, wherein the format is displayed on paper or on a screen.

37. The form according to claim 36, wherein said form has thereon a bar code or an identification number identifying the form.
